(19) United States
(12) Patent Application Publication
(10) Pub. No.: US 2012/0281426 A1
(43) Pub. Date: Nov. 8, 2012

(54) Lighting Mounting System

(75) Inventors: John Polka, Gurnee, IL (US); Cory Polka, Gurnee, IL (US)

(73) Assignee: REALWHEELS CORPORATION, Gurnee, IL (US)

(21) Appl. No.: 13/100,469

(22) Filed: May 4, 2011

(51) Int. Cl. B60Q 1/18; B60Q 1/00

(52) U.S. Cl. 362/549

(57) ABSTRACT

A light mounting system for a vehicle which includes a light mount surface with first and second ends defining a mounting area spanning there between and including a first and second mounting bracket spaced along the light mount surface and extending from the light mount surface for positioning the light mount surface within a vehicle license plate mounting area. The light mount surface extends away from the vehicle when positioned within the vehicle license plate mounting area and receives a light fixture mounted thereto. The light mount surface may include a wire routing way to provide a routing path for routing wire from the light fixture. In one embodiment, the light mount surface includes a wire routing way which is defined by an opening on the light mount surface when the light mount system is positioned within the license plate mounting area and proximate to the bumper of a vehicle. In one embodiment, the license plate mounting area includes apertures which align with apertures on the first and second mounting brackets to secure the light mounting system within the license plate mounting area on the vehicle.

### FIELD OF THE INVENTION

The field relates generally to light mounting systems and, more particularly, to systems for mounting auxiliary lights to vehicles.

### BACKGROUND

Auxiliary lights are frequently added to vehicles such as cars, pickup trucks, sport utility vehicles and other off road and recreational vehicles to customize the vehicle and to supplement the vehicle's regular headlights. Auxiliary lights including auxiliary driving lights, fog lights and the like enhance illumination of the road and surrounding areas as well as the driver's road awareness in low visibility weather conditions, such as fog and rain. Often the auxiliary lights are mounted above the vehicle passenger cab. However, such auxiliary lights require additional mounting hardware, causing additional apertures and mounting holes in the vehicle to properly affix the lights in such locations. In addition, mounting above the vehicle cab further removes the light beam from the road. Such distance typically requires that the power of the lights be increased or style of the lights be modified from those that may be used to obtain the desired optical pattern. Such placement also tends to alter the light pattern and throw of the auxiliary lights. Such changes are not desirable and, in fact, must be avoided. In addition, passenger cab mounted vehicle auxiliary lights increase the height clearance required for the vehicle and increase the risk of breakage due to the extended distance above the cab or passenger compartment.

Auxiliary lights may also be mounted below the vehicle front bumper. However, such bumper mounted auxiliary lights decrease the vehicle bottom clearance and are susceptible to breakage when the auxiliary lights are placed in close proximity to the road. Therefore, it is desirable to provide a mounting system for vehicle auxiliary lights that places the lights in a position above the bumper in a location noticeable and functional for the driver and observers. It is also desirable to provide a mounting system that does not adversely affect vehicle clearance requirements, and securely affixes the auxiliary lights to the vehicle without the need to place additional holes or apertures in the vehicle. Accordingly, it is desirable to mount auxiliary lights with a universal mounting system using the fasteners which attach the license plate to the vehicle. Mounting in this manner avoids drilling or otherwise having to place additional apertures or holes into the body, bumper, grill or any other portion of the vehicle, thereby avoiding potential rust, excess holes, paint damage and the like which may be caused by drilling into the vehicle body, bumper grill or similar body panel. Such advantages are desired by owners of vehicles including cars, pick-up trucks, truck cabs, all terrain vehicles, off-road vehicles, sport utility vehicles (SUVs) and any other vehicle that may be customize for a given purpose or desire. Auxiliary lights are often preferred by the owners of all types of vehicles to improve the appearance of their respective vehicles by customizing the vehicle and increasing the notoriety and attractiveness of the vehicle to both the owner and observers.

### SUMMARY

The present invention provides a light mounting system for a vehicle having a light mount surface including first and second ends defining a mounting area spanning between the first and second ends. The light mount system includes a first mounting bracket and a second mounting bracket spaced along the light mount surface and extending from the light mount surface for positioning the light mount surface within a vehicle license plate mounting area. The light mount surface extends away from the vehicle when positioned within the vehicle license plate mounting area and receives a light fixture which may be mounted thereto. The light mount surface defines a wire routing way to provide a routing path for a wire from the light fixture to the vehicle.

In one embodiment the first and second mounting brackets of the light mounting system extend below the light mount surface and include apertures which align with apertures of the license plate mounting area. In another embodiment the first and second mounting brackets are formed integrally with the light mount surface. In yet another embodiment, the light mount surface of the light mounting system includes an aperture for mounting the light fixture. In a further embodiment, the first and second mounting brackets include apertures therein and the license plate mounting area defines apertures therein. The apertures included in the first and second mounting brackets may be aligned with the apertures defined by the license plate mounting area. In another embodiment, the light mounting system has a wire routing way which includes an opening formed in the light mount surface. In a further embodiment the opening formed in the light mount surface forms an aperture for routing the wire from the light fixture when the light mount surface and first and second light mount brackets are positioned within the license plate mounting area. In yet another embodiment, the vehicle includes a bumper and the opening formed in the light mount surface forms an aperture when the light mount surface and the first and second light mount bracket are positioned within the license plate mounting area and the light mount surface is positioned proximate to the bumper. In another embodiment, the light mount surface and the first and second light mount brackets are of a single piece construction.

In a further embodiment, a vehicle light mount is provided which includes a light mount surface having first and second ends defining a mounting area spanning between the first and second ends and a first mounting bracket and a second mounting bracket spaced along the light mount surface and extending from the light mount surface for positioning the light mount surface within a vehicle license plate mounting area. The light mount surface extends away from the vehicle when positioned within the vehicle license plate mounting area and receives a light fixture mounted thereon. The light mount surface further defines a wire routing way when the light mount surface is positioned within the vehicle license plate mounting area to provide a routing path for a connecting wire from the light fixture to the vehicle.

In yet another embodiment, a light mounting system for a vehicle includes a light mount surface having first and second ends defining a mounting area spanning between the first and second ends, and first and second mounting brackets spaced along the light mount surface and extending from the light mount surface for securing the light mount surface to a vehicle license plate mounting area. The light mount surface extends away from the vehicle when secured to the vehicle license plate mounting area and receives a light fixture mounted thereon with the light mount surface defining a wire routing way when the light mount surface is secured to the vehicle license plate mounting area to provide a routing path for a connecting wire from the light fixture through the light mount surface to the vehicle.

Further exemplary apparatus and systems for mounting vehicle lights may be implemented in accordance with the principals described herein.

### BRIEF DESCRIPTION OF THE DRAWINGS

Exemplary systems and apparatus for light mounting systems for a vehicle may be understood by reference to the following description taken in conjunction with the accompanying drawings, in which like reference numerals identify like elements throughout the different views. The drawings are not necessarily to scale, emphasis instead being placed upon illustrating the principles of the invention. The drawings depict only embodiments of the invention and are not to be considered limiting of the scope of the invention in any way. In the accompanying drawings:

FIG. 1 is a perspective view of a vehicle light mounting system according to a first preferred embodiment of the present invention shown mounted to a vehicle;

FIG. 2 is an exploded perspective view of the vehicle light mounting system of FIG. 1 showing the bracket assembly thereof;

FIG. 3 is an enlarged perspective view of the bracket assembly shown in FIG. 2;

FIG. 4 is a front plan view of the bracket assembly shown in FIG. 3;

FIG. 5 is a top view of the bracket assembly shown in FIG. 3;

FIG. 6 is a side view of the bracket assembly shown in FIG. 3; and

FIG. 7 is rear view of a of the bracket assembly shown in FIG. 3.

### DETAILED DESCRIPTION

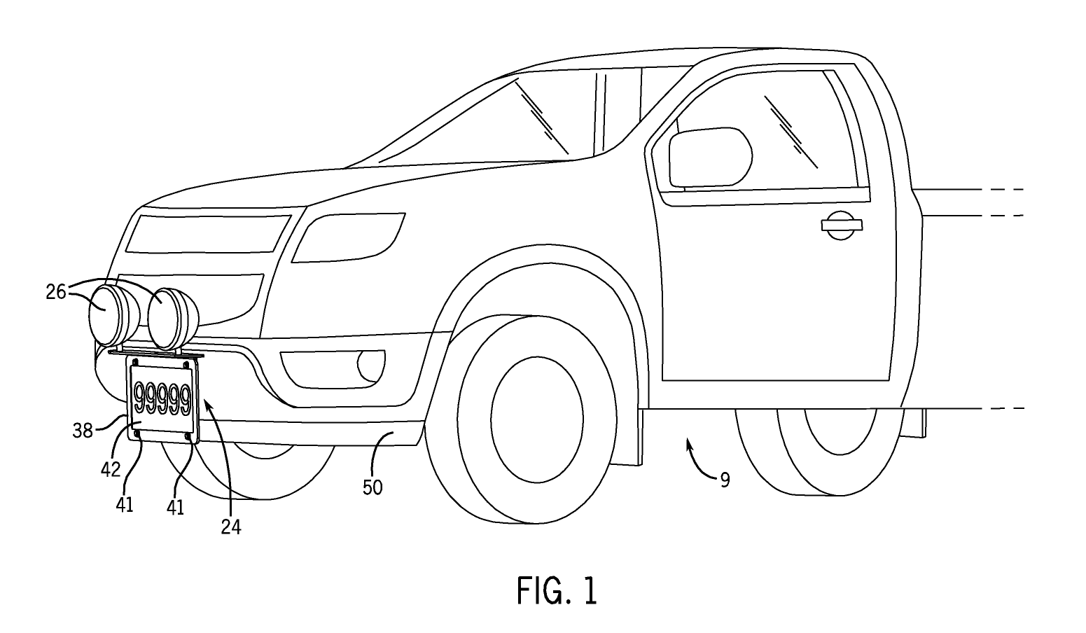

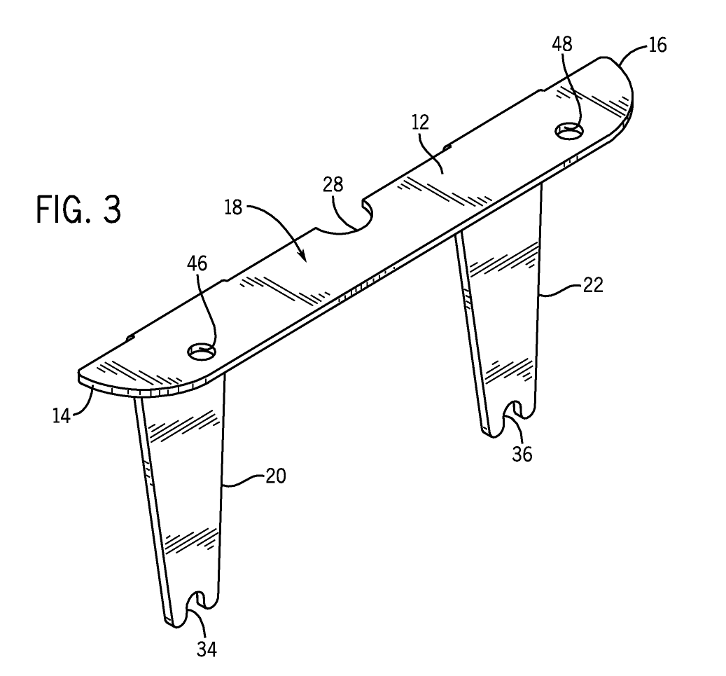

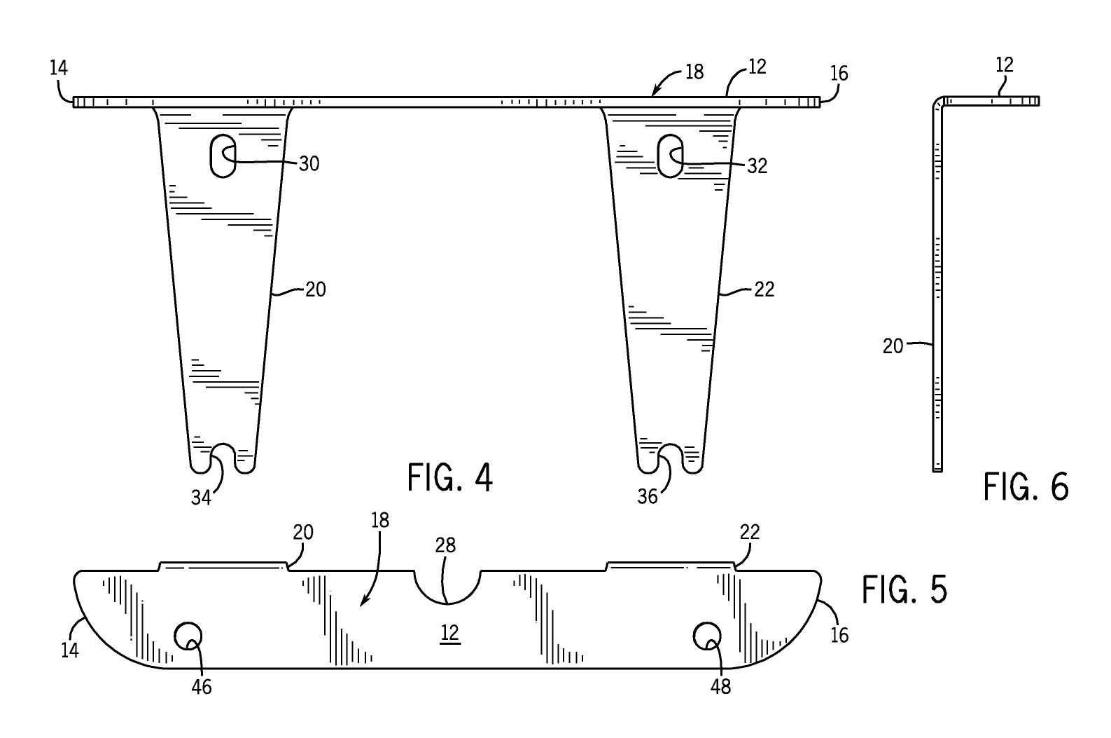

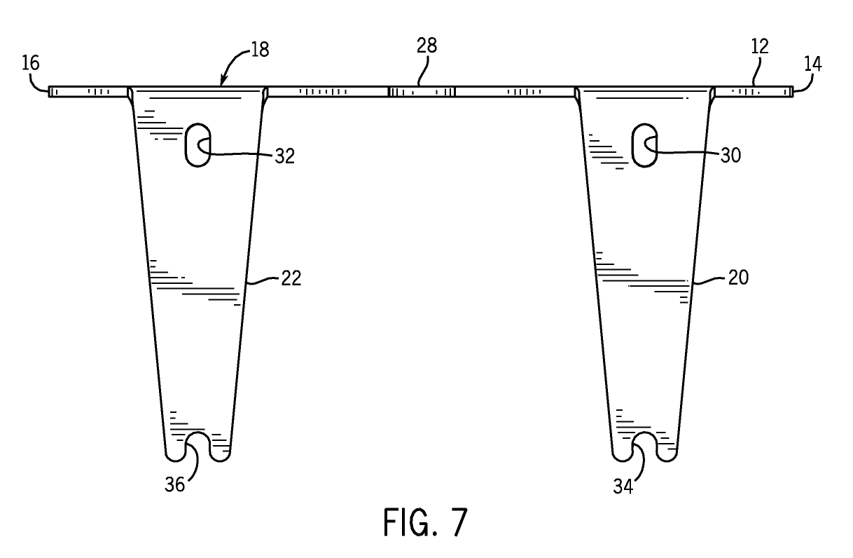

An exemplary vehicle light mounting system 10 will be described with respect to FIGS. 1-7. The exemplary vehicle light mounting system 10 provides for improved location and mounting of auxiliary vehicle lights in the license plate area of a vehicle. As a result, no additional holes or apertures are required to be drilled or otherwise located in a vehicle body, bumper or grill to achieve the mounting of the auxiliary lights resulting in an improved, cost effective mounting system for such lights.

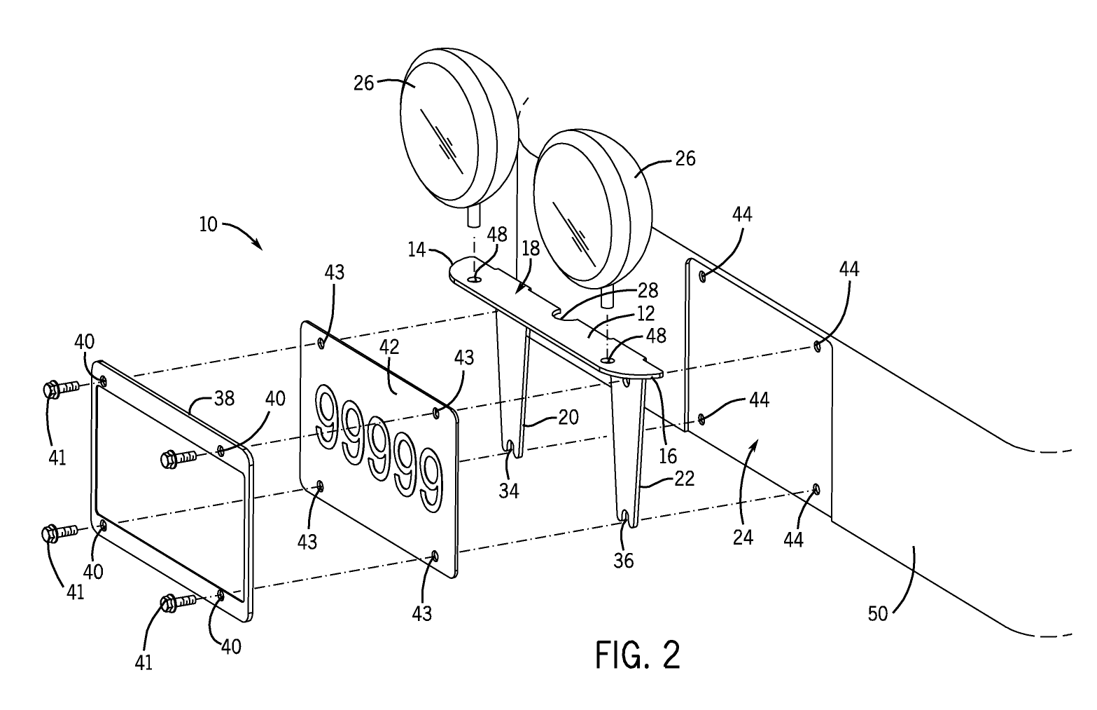

It should be understood that several preferred embodiments of the present invention are described herein and they are thus representative of the subject matter which is broadly contemplated by the present invention. The scope of the present invention fully encompasses other embodiments and equivalents. Features and advantages of the present invention will become more fully apparent from the following description and appended claims. Referring now to the drawings, FIGS. 1 and 2 show a light mounting system for a vehicle such as motor vehicle 9 according to a first preferred embodiment of the present invention generally at 10. The system includes a light mount surface 12 including a first end 14 and a second end 16 which define a mounting area 18 spanning between the first and second ends 14, 16. A first mounting bracket 20 and a second mounting bracket 22 are spaced along the light mount surface 12 and extending therefrom for positioning the light mount surface 12 within a vehicle license plate mounting area 24. The light mount surface 12 extends away from motor vehicle 9 when positioned within the vehicle license plate mounting area 24 and receives a light fixture 26 mounted thereto. One or more light fixtures 26 may be mounted on the mounting surface 12. Such light fixtures may include driving lights, fog lights, spot lights or any other type of auxiliary lighting. The light mount surface 12 further defines a wire routing way 28 to provide a routing path for a wire (not shown) from light fixture 26.

As can be seen in FIGS. 1 - 7, a preferred embodiment includes first mounting bracket 20 and second mounting bracket 22 extend below the light mount surface 18 and include apertures 30, 32, which align with several apertures 25 of the license plate mounting area 24. In addition, brackets 20 and 22 may include respective slots 34, 36 at the bottom thereof. Slots 34, 36 align with several apertures 44 located within the license plate mounting area to allow further positioning, alignment and securing of mounting brackets 20, 22 to license plate mounting area 24.

In one preferred embodiment, license plate frame 38 includes apertures 40 which allow a license plate or other vehicle tag 42 having apertures 43 to be secured within license plate mounting area 24 when fasteners 41 are positioned through apertures 40, apertures 43, apertures 30, 32, slots 34, 36 and apertures 44. It may be appreciated that license plate frame 38 need not be included, however the light mounting system will be installed and operate in the same way as described herein. In other preferred embodiments, first and second mounting brackets 20, 22 may be formed integrally with the light mount surface 12. In yet other preferred embodiments, brackets 20, 22 and light mount surface 12 may be of a single piece construction. In further preferred embodiments, light mount surface 12 may include one or more apertures 40 for mounting one or more light fixtures 26. As can be seen in FIGS. 1 and 2, first and second mounting brackets 34, 36 may include apertures 30, 32 and slots 34, 36 therein. License plate mounting area 24 also defines apertures 44 therein. Apertures 30, 32 and slots 34, 36 included in first and second mounting brackets 20, 22 are aligned with apertures 44 defined by the license plate mounting area 24 for installation of the light mounting system 10. Slots 34, 26 also provide adjustability of brackets 20, 22 within vehicle license plate mounting area 24 and hence allow positioning of the light mounting system 10 with respect to vehicle 9. Such alignment and adjustability, as described above, eliminates the need to drill any additional holes, apertures or the like in or through the bumper, body, license plate mounting area 24 or any other panel on the vehicle 9. As can be seen in FIGS. 2, 3, 4 and 7, another preferred embodiment includes wire routing way 28 formed in light mounting surface 12 may be an opening or slot of any configuration including a semi-circle, rectangle, triangle or the like formed in light mount surface 12. The opening formed in light mount surface 12 defining wire routing way 28 may form an aperture for routing a connecting wire or a wire harness (not shown) from light fixture 26 when light mount surface 12 and first and second light mount brackets 20, 22 are positioned within license plate mounting area 24 and secured thereto as described above. Vehicle 9 typically includes a bumper such as bumper 50 shown in FIG. 1. Wire routing way 28 in light mount surface 12 may also form an aperture when light mount surface 12 and first and second light mount brackets 20, 22 are positioned within license plate mounting area 24 and light mount surface 12 is positioned proximate to bumper 50. In such a configuration, light mounting surface 12 forms a platform for mounting lights 26 which extend out from bumper 50. Hence light mounting surface 12 forms a base to assist in supporting lights 26 when they are mounted in position for use. It may be appreciated that first and second light mount brackets 20, 22, light mount surface 12 including surface 18 may be constructed of steel, stainless steel, aluminum or other lightweight durable material which allows apertures to be formed, drilled or otherwise positioned therein. It will also be appreciated that a solid piece of material may be formed, bent, machined or otherwise constructed to form brackets 20, 22, light mount surface 12 including surface 18 and apertures 30, 32, 46 and 48, as well as slots 34, 36. It is preferred that the material from which the light mounting system is formed be approximately 1/16″ (16 gauge) to approximately ⅜″ (000 gauge) in thickness and most preferably approximately ⅛″ thick (11 gauge). It is preferred that of mounting brackets 20, 22 be approximately 7″ on center apart, but this distance can be altered based on the specific vehicle on which the light mounting system is to be installed. It is preferred that mounting brackets 20, 22 be approximately 5.5″ to approximately 6.5″ in length. Other mounting bracket lengths, aperture spacing, slot configurations and/or slot dimensions may be used depending on the vehicle on which the system is to be installed.

It should also be appreciated that the configurations of brackets 20, 22 and light mount surface 12 may be altered to conform to particular license plate mounting areas and/or particular bumper configurations, thereby allowing the vehicle light mounting system described herein to be utilized in a wide variety of vehicles having varying license plate mounting area configurations, as well as various bumper and bumper mount structures. Therefore, it should be appreciated that the vehicle light mounting system described herein may be added as a feature during initial vehicle assembly and manufacture, or may be sold and installed as an aftermarket product.

The light mounting system described herein provides an effective system for mounting auxiliary lights at a desirable location for maximum light effectiveness. The light mount system effectively eliminates the need to place additional mounting apertures or holes in the vehicle and minimize the exposure of the light mounting system to undesirable impact forces typically absorbed by a vehicle bumper. While the above description constitutes the preferred embodiment of the present invention, it should be appreciated that the invention may be modified without departing from the scope or fair meaning of the accompanying claims. Various other advantages of the present invention will become apparent to those skilled in the art after having the benefit of studying the foregoing text and drawings taken in conjunction with the following claims. Reference throughout this specification to “the embodiment,” “this embodiment,” “the previous embodiment,” “one embodiment,” “an embodiment,” “a preferred embodiment,” “another preferred embodiment,” “further preferred embodiment,” or similar language means that a particular feature, structure, or characteristic described in connection with the embodiment is included in at least one embodiment of the present invention. Thus, appearances of the phrases “in the embodiment,” “in this embodiment,” “in the previous embodiment,” “in one embodiment,” “in an embodiment,” “in a preferred embodiment,” “in another preferred embodiment,” “in a further preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. While the present invention has been described in connection with certain exemplary or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, equivalents and the like may be made without departing from the spirit and scope of the invention.

What is claimed is:

1. A light mounting system for a vehicle comprising:
a light mount surface including first and second ends defining a mounting area spanning between the first and second ends;
a first mounting bracket and a second mounting bracket spaced along the light mount surface and extending from the light mount surface for positioning the light mount surface within a vehicle license plate mounting area;
the light mount surface extending away from the vehicle when positioned within the vehicle license plate mounting area and receiving a light fixture mounted thereto, the light mount surface further defining a wire routing way to provide a routing path for a wire from the light fixture.

2. The light mounting system of claim 1, wherein the first and second mounting brackets extend below the light mount surface and include apertures which align with apertures of the license plate mounting area.

3. The light mounting system of claim 1, wherein the first and second mounting brackets are formed integrally with the light mount surface.

4. The light mounting system of claim 1, wherein the light mount surface includes an aperture for mounting the light fixture.

5. The light mounting system of claim 1, wherein the first and second mounting brackets include apertures therein and the license plate mounting area defines apertures therein, the apertures included in the first and second mounting brackets may be aligned with the apertures defined by the license plate mounting area.

6. The light mounting system of claim 1, wherein the wire routing way comprises an opening formed in the light mount surface.

7. The light mounting system of claim 6, wherein the opening formed in the light mount surface forms an aperture for routing the wire from the light fixture when the light mount surface and first and second light mount brackets are positioned within the license plate mounting area.

8. The light mounting system of claim 6, the vehicle including a bumper and wherein the opening formed in the light mount surface forms an aperture when the light mount surface and the first and second light mount bracket are positioned within the license plate mounting area and the light mount surface is positioned proximate to the bumper.

9. The light mounting system of claim 1, wherein the light mount surface and the first and second light mount brackets are of a single piece construction.

10. A vehicle light mount, comprising:
a light mount surface including first and second ends defining a mounting area spanning between the first and second ends;
a first mounting bracket and a second mounting bracket spaced along the light mount surface and extending from the light mount surface for positioning the light mount surface within a vehicle license plate mounting area;
the light mount surface extending away from the vehicle when positioned within the vehicle license plate mounting area and receiving a light fixture mounted thereto, the light mount surface further defining a wire routing way when the light mount surface is positioned within the vehicle license plate mounting area to provide a routing path for a connecting wire from the light fixture.

11. The light mount of claim 10, wherein the first and second mounting brackets extend below the light mount surface and include apertures which align with apertures located within the license plate mounting area.

12. The light mount of claim 10, wherein the first and second mounting brackets are formed integrally with the light mount surface.

13. The light mount of claim 10, wherein the light mount surface includes at least one aperture for mounting the light fixture.

14. The light mount system of claim 10, wherein the first and second mounting brackets include apertures therein and the license plate mounting area defines apertures therein, the apertures included in the first and second mounting brackets align with the apertures defined by the license plate mounting area to install the light mount on the license plate mounting area.

15. The light mount of claim 10, wherein the wire routing way comprises an opening formed in the light mount surface.

16. The light mount of claim 15, wherein the opening formed in the light mount surface forms an aperture for routing the wire from the light fixture when the light mount surface and first and second light mount brackets are positioned within the license plate mounting area.

17. The light mount of claim 16, the vehicle including a bumper and wherein the opening formed in the light mount surface forms an aperture when the light mount surface and the first and second light mount bracket are positioned within the license plate mounting area and the light mount surface is positioned proximate to the bumper.

18. The light mount of claim 10, wherein the light mount surface and the first and second light mount brackets are of a single piece construction.

19. A light mounting system for a vehicle comprising:
a light mount surface including first and second ends defining a mounting area spanning between the first and second ends;
a first mounting bracket and a second mounting bracket spaced along the light mount surface and extending from the light mount surface for securing the light mount surface to a vehicle license plate mounting area;
the light mount surface extending away from the vehicle when secured to the vehicle license plate mounting area and receiving a light fixture mounted thereto, the light mount surface further defining a wire routing way when the light mount surface is secured to the vehicle license plate mounting area to provide a routing path for a connecting wire from the light fixture to the vehicle.
